(19) United States
(12) Patent Application Publication
(10) Pub. No.: US 2024/0331542 A1
(43) Pub. Date: Oct. 3, 2024

(54) SAFE DRIVING ASSISTANCE SYSTEM, SAFE DRIVING ASSISTANCE METHOD, AND PROGRAM-RECORDING MEDIUM

(71) Applicant: NEC Corporation, Minato-ku, Tokyo (JP)

(72) Inventor: Nobuyuki TOZAWA, Tokyo (JP)

(73) Assignee: NEC Corporation, Minato-ku, Tokyo (JP)

(21) Appl. No.: 18/293,812

(22) PCT Filed: Sep. 17, 2021
(86) PCT No.: PCT/JP2021/034298

§ 371 Date: Jan. 31, 2024

(51) Int. Cl. G08G 1/16; G06V 20/52; G06V 40/10; G06V 40/20; G08G 1/01; G08G 1/052; G08G 1/056

(52) U.S. Cl. CPC G08G 1/164; G06V 20/52; G06V 40/10; G06V 40/20; G08G 1/0116; G08G 1/0141; G08G 1/0145; G08G 1/052; G08G 1/056; G08G 1/166

(57) ABSTRACT

A safe driving assistance system according to an aspect of the present disclosure includes: at least one memory configured to store instructions; and at least one processor configured to execute the instructions to: detect a person or an animal crossing or likely to cross a road based on an image acquired from a camera capable of photographing the road; determine whether a crossing position of the detected person or animal is within a pedestrian crossing; and output result of the determination.

### TECHNICAL FIELD

The present invention relates to a safe driving assistance system, a safe driving assistance device, a safe driving assistance method, and a program-recording medium.

### BACKGROUND ART

PTL 1 discloses a roadside device capable of determining a situation of a sidewalk. According to PTL 1, the roadside device includes a camera that is a detection unit that detects information capable of determining a situation of a sidewalk around the own device, a communication unit that communicates with another device (in-vehicle device or mobile electronic device (e.g., a smartphone)), and a control unit. In addition, it is described that the control unit determines the situation of the sidewalk around the own device based on the information detected by the camera, and transmits the determined situation of the sidewalk to another device. Furthermore, paragraph 0063 of this literature describes that the “situation of the sidewalk” notified by the roadside can include the presence or absence and the number of pedestrians and bicycles, information on whether the pedestrians include children or elderly people, and situations such as jumping out of the pedestrians and bicycles.

### CITATION LIST

### Patent Literature

PTL 1: WO 2018/061975 A1

### SUMMARY OF INVENTION

### Technical Problem

The following analysis was given by the inventor. According to the invention of Patent Literature 1, it is possible to notify another device (in-vehicle device or mobile electronic device (e.g., a smartphone)) of the situation of the sidewalk, but there is a problem that it is not possible to notify a pedestrian or a bicycle outside the sidewalk, for example, running out to a roadway or crossing the roadway.

In the future, with the spread of the automatic driving technology, there is a possibility that the detection accuracy of a pedestrian and a bicycle by an in-vehicle camera will improve, but in the in-vehicle camera, there is a possibility that the finding of the pedestrian and the bicycle may be delayed since the viewpoint is low and the viewing angle is also limited. In addition, there are places where crossing the outside of a pedestrian crossing or diagonal crossing is routinely performed, which is originally prohibited by the Road Traffic Act, depending on the road, and prompt measures are desired. In some areas, an accident in which a vehicle collides with a wild animal or the like occurs.

An object of the present invention is to provide a safe driving assistance system, a safe driving assistance device, a safe driving assistance method, and a program-recording medium that can contribute to early finding of a person or an animal crossing the outside of a pedestrian crossing or diagonally crossing.

### Solution to Problem

According to a first aspect, there is provided a safe driving assistance system including: a detection means that detects a person or an animal crossing or likely to cross a road based on an image acquired from a camera capable of photographing the road, a determination means that determines whether a crossing position of the detected person or animal is within a pedestrian crossing, and an output means that outputs result of the determination.

According to a second aspect, there is provided a safe driving assistance device connected to a server including a detection means that detects a person or an animal crossing or likely to cross a road based on an image acquired from a camera capable of photographing the road, and a transmission means that transmits the detection result of the person or the animal, the safe driving assistance further including: a means that determines whether a crossing position of the person or the animal is within a pedestrian crossing based on the detection result of the person or the animal received from the server, and a means that outputs result of the determination.

According to a third aspect, there is provided a safe driving assistance method including: detecting a person or an animal crossing or likely to cross a road based on an image acquired from a camera, determining whether a crossing position of the detected person or animal is within a pedestrian crossing, and outputting result of the determination.

According to a fourth aspect, there is provided a safe driving assistance method including: receiving, from a server including a detection means that detects a person or an animal crossing or likely to cross a road based on an image acquired from a camera capable of photographing the road, and a transmission means that transmits the detection result of the person or the animal, the detection result of the person or the animal, determining whether a crossing position of the person or the animal is within a pedestrian crossing based on the detection result of the person or the animal received from the server, and outputting result of the determination.

According to a fifth aspect, there is provided a program-recording medium recorded with a program for causing a computer capable of acquiring an image from a camera to execute: a process of detecting a person or an animal crossing or likely to cross a road based on an image acquired from a camera, a process of determining whether a crossing position of the detected person or animal is within a pedestrian crossing, and a process of outputting result of the detection and result of the determination.

### Advantageous Effects of Invention

According to the present invention, it is possible to contribute to early finding of a person or an animal crossing outside a pedestrian crossing or performing diagonal crossing.

### BRIEF DESCRIPTION OF DRAWINGS

FIG. 1 is a diagram illustrating a configuration according to one example embodiment of the present invention.

FIG. 2 is a flowchart illustrating a flow of operation according to one example embodiment of the present invention.

FIG. 3 is a diagram for explaining an operation according to one example embodiment of the present invention.

FIG. 4 is a diagram illustrating a schematic configuration according to a first example embodiment of the present invention.

FIG. 5 is a functional block diagram illustrating a configuration of a server according to the first example embodiment of the present invention.

FIG. 6 is a sequence diagram illustrating the operation according to the first example embodiment of the present invention.

FIG. 7 is a diagram for explaining an operation of the server according to the first example embodiment of the present invention.

FIG. 8 is another diagram for explaining an operation of the server according to the first example embodiment of the present invention.

FIG. 9 is another diagram for explaining an operation of the server according to the first example embodiment of the present invention.

FIG. 10 is a sequence diagram illustrating a modified operation according to the first example embodiment of the present invention.

FIG. 11 is a diagram illustrating a schematic configuration according to a second example embodiment of the present invention.

FIG. 12 is a functional block diagram illustrating a configuration of a server according to the second example embodiment of the present invention.

FIG. 13 is a sequence diagram illustrating the operation according to the second example embodiment of the present invention.

FIG. 14 is a diagram illustrating a schematic configuration according to a third example embodiment of the present invention.

FIG. 15 is a functional block diagram illustrating a configuration of a server according to the third example embodiment of the present invention.

FIG. 16 is a sequence diagram illustrating the operation according to the third example embodiment of the present invention.

FIG. 17 is a diagram for explaining an operation of the server according to the third example embodiment of the present invention.

FIG. 18 is another diagram for explaining an operation of the server according to the third example embodiment of the present invention.

FIG. 19 is a diagram illustrating a configuration of a computer that can function as a server of the present invention.

FIG. 20 is a functional block diagram illustrating a modified configuration of the first example embodiment of the present invention.

### EXAMPLE EMBODIMENT

First, an outline of one example embodiment of the present invention will be described with reference to the drawings. The reference numerals in the drawings attached to this outline are attached to each element for convenience as an example for assisting understanding, and are not intended to limit the present invention to the illustrated aspects. In addition, connection lines between blocks in the drawings and the like referred to in the following description include both bidirectional and unidirectional. The unidirectional arrow schematically indicates a flow of a main signal (data), and does not exclude bidirectionality. In addition, although there are ports and interfaces at connection points of input and output of each block in the drawing, the illustration thereof will be omitted.

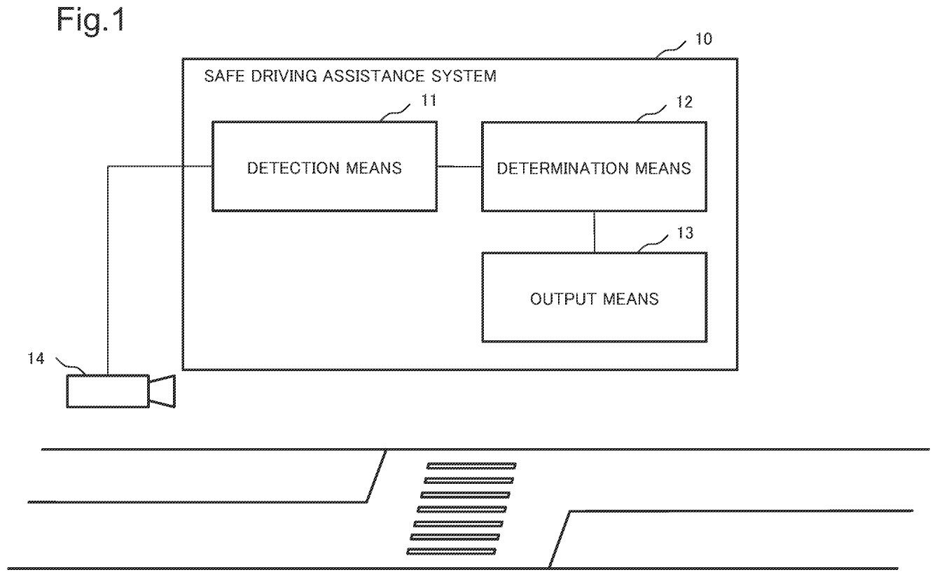

In one example embodiment, as illustrated in FIG. 1, the present invention can be achieved by a safe driving assistance system 10 including a detection means 11, a determination means 12, and an output means 13.

The detection means 11 detects a person or an animal crossing or likely to cross the road based on an image acquired from a camera capable of photographing the road. As the camera 14, a camera that grasps a traffic flow and a situation in an intersection can be used. Of course, a security camera or a camera mounted on another moving body can be used as the camera 14. As a method for detecting a person or an animal from an image by the detection means 11, a method using a class identifier for identifying a class of an object in the image, or an object detection technique used in automatic driving or security field can be used.

The determination means 12 determines whether the crossing position of the detected person or animal is within a pedestrian crossing. Hereinafter, in the present specification, the term “crossing position” includes a position being crossed that is a current position when a person or an animal detected from an image is crossing a road, and a scheduled crossing position that is a predicted future position when the person or the animal crosses the road. In a case where the position of the pedestrian crossing in the image obtained by the camera 14 is known, the determination means 12 can determine whether the crossing position of the person or the animal is within the pedestrian crossing based on the position (coordinates in the image) of the person or the animal shown in the image. Furthermore, when determining whether the crossing position of the person or the animal is within the pedestrian crossing from the position of the person or the animal shown in the image (coordinates in the image), the size of the image of the person or the animal in the image may be taken into consideration in addition to the position of the image of the person or the animal in the image. In addition, in a case where the position of the pedestrian crossing is not known or the camera 14 is moving, it is also possible to adopt a method of determining whether the crossing position of the person or the animal is within the pedestrian crossing based on the image of the pedestrian crossing shown in the image. For example, a model in which a pattern of a pedestrian crossing is learned in advance may be used to detect a region where the pedestrian crossing is shown in an image, and when a crossing position of a person or an animal in the image and the region of the pedestrian crossing overlap or are close to each other, determination may be made that the crossing position is within the pedestrian crossing. Furthermore, in a case where the position of the pedestrian crossing can be acquired as the position information on the map information, it is also possible to adopt a method of determining whether the crossing position of the person or the animal is within the pedestrian crossing by obtaining the crossing position of the person or the animal on the map information.

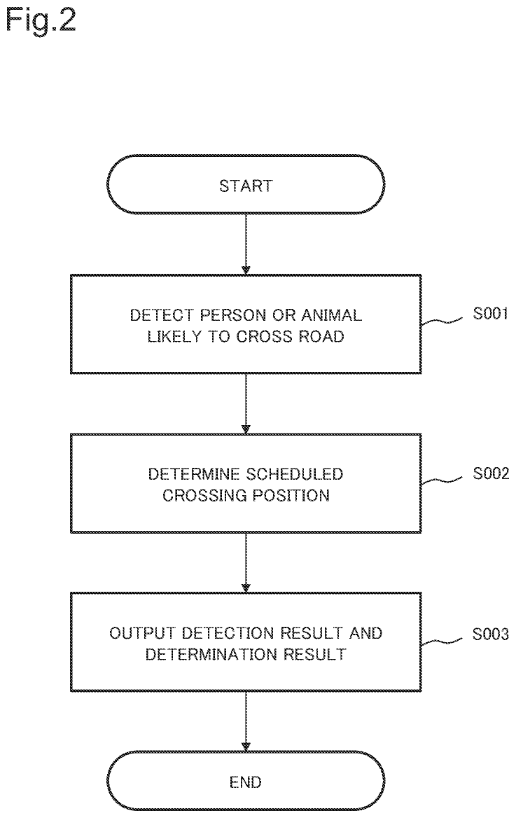

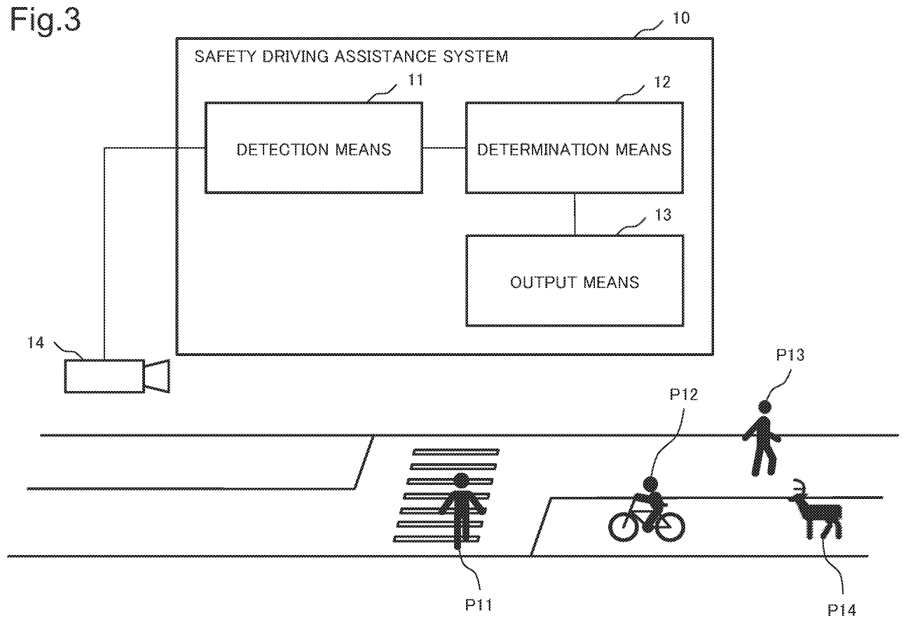

The output means 13 outputs the result of the detection and the result of the determination to a predetermined output destination. The output destination of the information of the output means 13 may be a vehicle having the possibility of crossing (colliding with) the person or the animal. In addition, as another aspect, the output means 13 may be configured to output these pieces of information to an electric bulletin board or a large display installed at a position easily seen by a driver of the vehicle, such as near a road, as an output destination. FIG. 2 is a flowchart illustrating a flow of operation of the safe driving assistance system 10. As illustrated in FIG. 2, the safe driving assistance system 10 detects a person or an animal crossing or likely to cross the road based on the image acquired from the camera 14 (step S001). For example, the safe driving assistance system 10 detects pedestrians P11 and P13, a bicycle P12, and an animal P14 in FIG. 3 based on the image acquired from the camera 14.

Next, the safe driving assistance system 10 determines whether the crossing position of the detected person or animal is within the pedestrian crossing. For example, the safe driving assistance system 10 determines that the pedestrian P11 in FIG. 3 is at a position of crossing within the pedestrian crossing. On the other hand, the safe driving assistance system 10 determines that the bicycle P12, the pedestrian P13, and the animal P14 in FIG. 3 are at positions of crossing the outside of the pedestrian crossing.

Finally, the safe driving assistance system 10 outputs the result of the detection and the result of the determination to a predetermined output destination. The safe driving assistance system 10 notifies a vehicle traveling on a road of the presence of the bicycle P12, the pedestrian P13, and the animal P14 in FIG. 3 and the fact that they are at positions of crossing the outside of the pedestrian crossing. As a result, a driver driving a vehicle traveling on this road can take measures such as paying attention to the front or decelerating.

As described above, according to the present example embodiment, it is possible to prevent an accident by finding a person or an animal crossing the outside of a pedestrian crossing or crossing diagonally at an early stage and notifying a vehicle or the like of the finding.

### First Example Embodiment

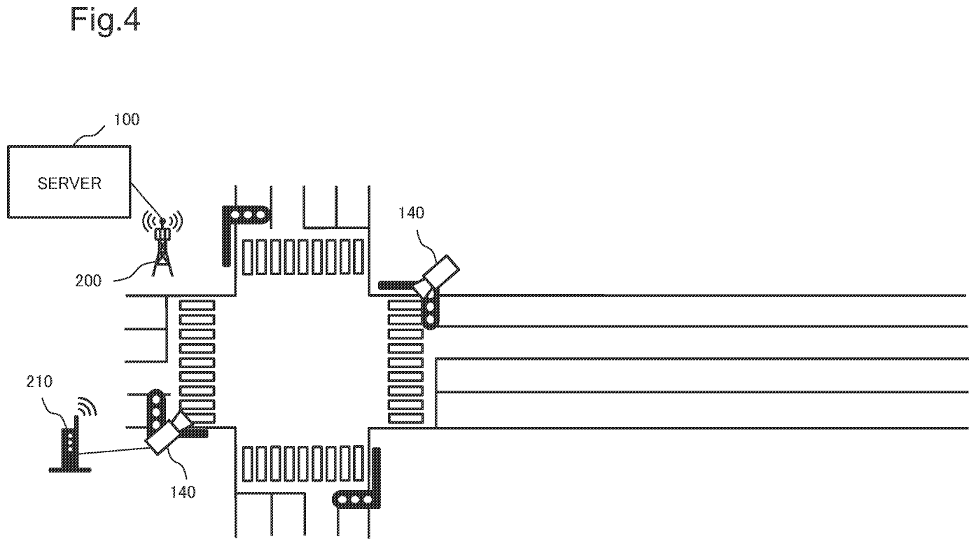

Next, a first example embodiment of the present invention will be described in detail with reference to the drawings. FIG. 4 is a diagram illustrating a schematic configuration of the first example embodiment of the present invention. Referring to FIG. 4, a configuration including a server 100, a base station 200, a terminal 210, and a camera 140 is shown.

The camera 140 is a camera that is installed near a traffic light at an intersection and photographs a vehicle or the like passing through the intersection where a pedestrian crossing is installed. In the present example embodiment, the camera 140 is used as a camera for detecting a person or an animal crossing a road at a place other than a pedestrian crossing. In the present example embodiment, a case where a pedestrian or an automobile is detected as a specific example of a person will be mainly described. Furthermore, in the example of FIG. 4, an example in which two cameras are arranged to face each other on the diagonal line of the intersection is illustrated, but the number of cameras is not limited. For example, one or more cameras may be installed on each signal pole of a traffic light at an intersection. Furthermore, in the example of FIG. 4, the camera 140 is directed to the inner side of the intersection, but a camera directed to the outer side of the intersection may be used.

The terminal 210 is a terminal having a function of wirelessly connecting to the base station 200. In the present example embodiment, the terminal 210 functions as a transmission device that transmits an image captured by the camera 140 to the server 100 via the base station 200. The terminal 210 may be a terminal for traffic control to transmit an image captured by the camera 140 to a traffic control center, a server, or the like via the base station 200.

The base station 200 transmits the camera image received from the terminal 210 to the server 100. In the base station 200, not only the terminal 210 but also an in-vehicle terminal of a vehicle passing near an intersection may be a base station that provides service to a terminal of a pedestrian. For example, the base station 200 may be a base station of a 5th generation mobile communication system installed by a telecommunications corporation, or may be a base station of a network operated by a person other than the telecommunications corporation called local 5G.

The server 100 is a server that detects a pedestrian or a bicycle attempting to cross the outside of the pedestrian crossing from an image captured by the camera 140 and notifies the vehicle of the pedestrian or the bicycle. The server 100 may be a server installed on a cloud base or the Internet, or may be an MEC server installed at a position physically close to the base station, where “MEC” is an abbreviation of Multi-access Edge Computing or Multi-access Edge Computing.

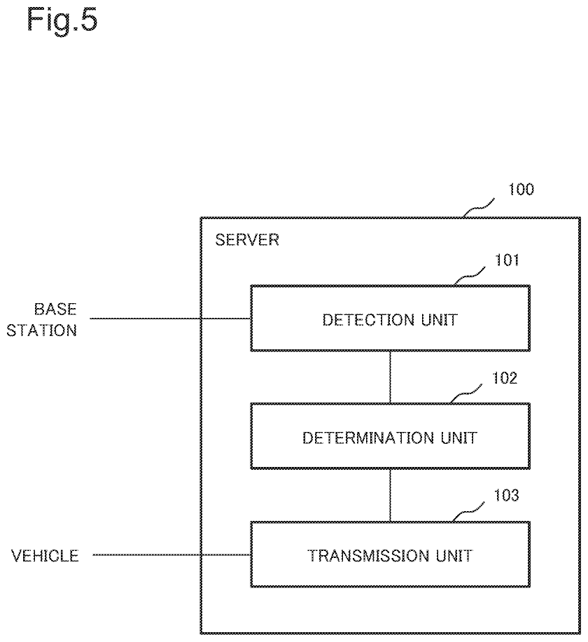

FIG. 5 is a functional block diagram illustrating a configuration of the server 100. Referring to FIG. 5, a configuration including a detection unit 101, a determination unit 102, and a transmission unit 103 is illustrated.

The detection unit 101 corresponds to the detection means 11 described above, and receives an image captured by the camera 140 from the base station 200. The detection unit 101 detects a pedestrian, a bicycle, or the like likely to cross a road in the image captured by the camera 140.

The determination unit 102 corresponds to the determination means 12 described above, and determines whether the pedestrian or the bicycle detected by the detection unit 101 is crossing or is about to cross within the pedestrian crossing. Very simply, the determination unit 102 can determine whether a pedestrian or a bicycle is crossing or is about to cross within the pedestrian crossing based on a position where the pedestrian or the bicycle is shown in the image of the camera 140. Furthermore, in the present example embodiment, the determination unit 102 specifies the position of a pedestrian or a bicycle. The position information here may be absolute coordinates such as latitude and longitude, or may be position information specified by information on an intersection and a relative position from the intersection.

The transmission unit 103 corresponds to the output means 13 described above, and transmits, to a vehicle approaching an intersection, the position of the detected pedestrian, bicycle, and the like, and a determination result as to whether the pedestrian, the bicycle, or the like is crossing or is about to cross within the pedestrian crossing. Various methods are conceivable as a transmission form of these pieces of information by the transmission unit 103. For example, a method in which the transmission unit 103 broadcasts these pieces of information via the base station 200 can be adopted. Furthermore, in a case where the server 100 can acquire the IP address or the like of the in-vehicle terminal of each vehicle, the server 100 may select a vehicle and transmit these pieces of information by multicast or unicast. Moreover, the transmission unit 103 may transmit these pieces of information by using a roadside device or the like installed on a road. In addition, the transmission unit 103 may add and transmit various types of information to the vehicle passing through the intersection in addition to the information described above. For example, the transmission unit 103 may transmit images of pedestrians and bicycles in the images obtained from the camera 140, attribute information obtained from these images, and the like to the vehicle.

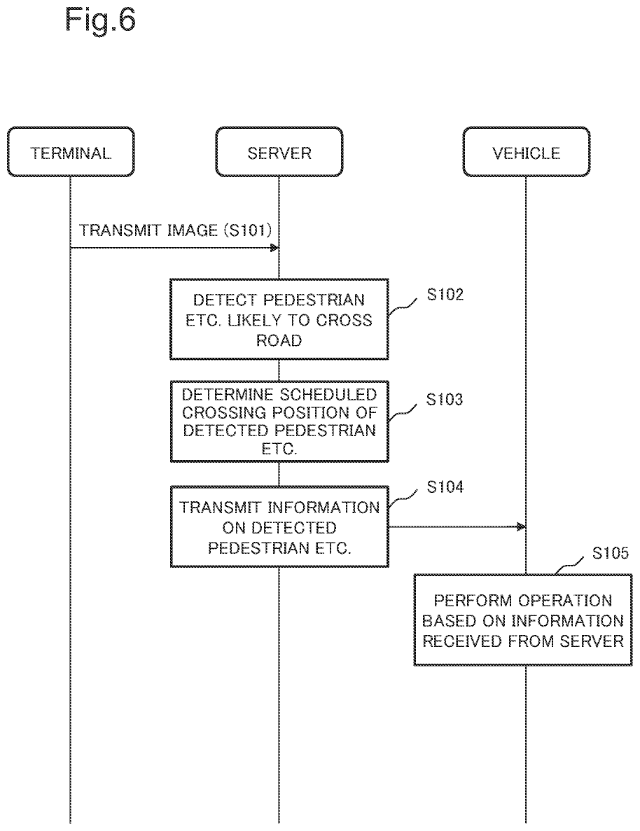

Next, the operation of the present example embodiment will be described in detail with reference to the drawings. FIG. 6 is a sequence diagram illustrating the operation of the first example embodiment of the present invention. Referring to FIG. 6, the terminal 210 transmits the image received from the camera 140 to the server 100 via the base station 200 (step S101).

The server 100 that has received the image detects a pedestrian or a bicycle crossing or likely to cross the road from the received image. The possibility of crossing the road may be determined based on a behavior of a pedestrian or a bicycle in advance, in addition to a case where an image of actually starting to cross the road is obtained. For example, in a case where there is a pedestrian on a curbstone of a road, or in a case where a pedestrian is heading toward a road in a place where there is no pedestrian crossing and checking left and right, it can be said that there is a high possibility that the pedestrian will cross the road from now. In addition, in a case where the traveling bicycle is wobbling or the vehicle changes the direction of the vehicle body and starts to cross the road, it can be determined that there is a high possibility of crossing the road in view of such. Alternatively, in a case where a person riding on a bicycle turns around to the roadway side, it can be said that there is a high possibility that the person will diagonally cross the road from now.

Next, the server 100 determines the current position of the detected pedestrian or the bicycle, and whether the crossing position is within the pedestrian crossing (step S103).

Next, the server 100 transmits, to the vehicle, the position of the detected pedestrian or the bicycle and information on whether the crossing position is within the pedestrian crossing (step S104).

The in-vehicle terminal of the vehicle that has received the information performs an operation based on the information received from the server 100 (step S105). Specifically, the in-vehicle terminal that has received the information determines whether to use the information received from the server 100 with reference to the position, the moving direction, and the moving speed of the own vehicle. For example, even if there is a pedestrian who is about to cross the outside of the pedestrian crossing, if the own vehicle is moving away from the pedestrian, there is no possibility of crossing (colliding with) the pedestrian, and thus the in-vehicle terminal that has received the information may discard these pieces of information. In addition, even in a case where the distance between the own vehicle and the pedestrian is short, if the own vehicle is stopped or the moving speed is slow, there is a low possibility of crossing (colliding with) the pedestrian, and thus the in-vehicle terminal that has received the information may discard these pieces of information. Furthermore, in a case where a pedestrian is about to cross within the pedestrian crossing, there is no immediate risk, and thus the in-vehicle terminal may discard these pieces of information.

On the other hand, in a case where the own vehicle is approaching a pedestrian who is about to cross the outside of the pedestrian crossing, the in-vehicle terminal warns the driver using these pieces of information. For example, the in-vehicle terminal displays the pedestrian and the position of the pedestrian notified from the server 100 using a display of a car navigation device or an augmented reality (AR) display. As a result, it is possible to cause the driver to take an action to avoid crossing (collision) with a pedestrian who is about to cross the outside of the pedestrian crossing.

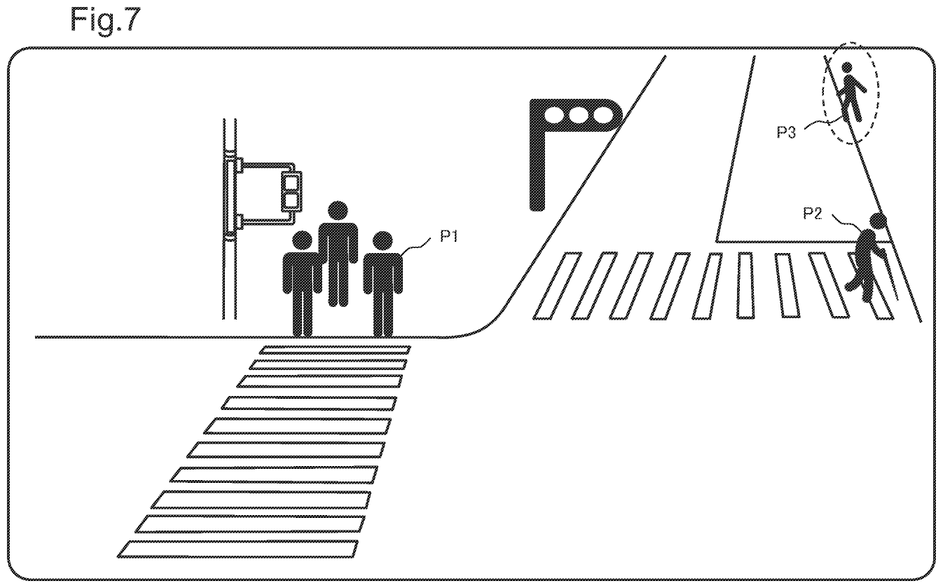

Next, a specific operation example of the server 100 of the present example embodiment will be described with reference to FIGS. 7 to 9. For example, assume that an image as illustrated in FIG. 7 is transmitted from the camera 140. In this case, the server 100 detects pedestrians P1 and P3 likely to cross the road from the image of FIG. 7. It is assumed that the pedestrian P2 who has crossed the pedestrian crossing has been detected at a previous timing.

Next, the server 100 determines whether the crossing positions of the detected pedestrians P1 and P3 are within the pedestrian crossing. For example, in the example of FIG. 7, since the pedestrian P1 is at the standby position in front of the pedestrian crossing, determination is made that the crossing position is within the pedestrian crossing. On the other hand, the pedestrian P3 appearing far is at a position other than the standby position of the pedestrian crossing, determination is made that the crossing position is outside the pedestrian crossing. When the server 100 transmits such a determination result together with the presence of the pedestrians P1 and P3, the in-vehicle terminal or the like can perform an operation of calling attention to the pedestrian P3 to the driver or the like of the vehicle. In addition, at this time, the in-vehicle terminal or the like may omit calling attention regarding the pedestrian P1 to the driver or the like of the vehicle in order to enhance the effect of calling attention to the pedestrian P3. This is because the pedestrian P1 is at the standby position of the pedestrian crossing, and there is a low possibility of crossing (colliding with) the vehicle.

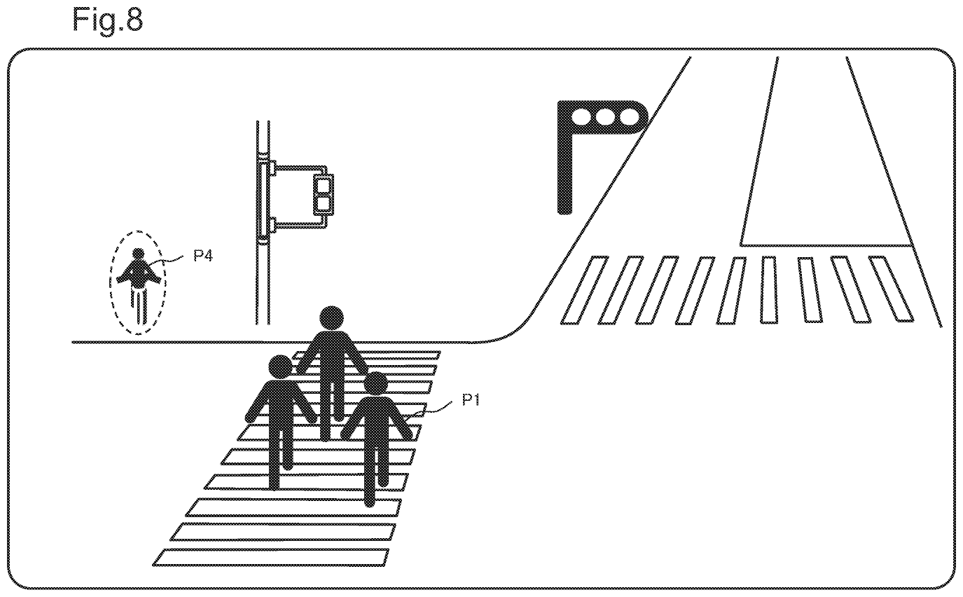

FIG. 8 is a diagram illustrating an image transmitted from the camera 140 after a certain time has elapsed from the time point of FIG. 7. In the example of FIG. 8, the pedestrian signal at which the pedestrian P1 has been waiting for a traffic light to change turned green, and the pedestrian P1 has started crossing. In addition, a bicycle P4 heading in the direction of the intersection is captured in the distance. In this case, the server 100 detects the bicycle P4 likely to cross the road from the image of FIG. 8. Since the pedestrian P1 who has started to cross the pedestrian crossing is at the crossing position within the pedestrian crossing, the pedestrian P1 is not subject to calling attention to the driver or the like of the vehicle.

Next, the server 100 determines whether the crossing position of the detected bicycle P4 is within the pedestrian crossing. For example, in the example of FIG. 8, the bicycle P4 is at a position other than the standby position of the pedestrian crossing, and thus determination is made that the crossing position is outside the pedestrian crossing. When the server 100 sends such a determination result together with the presence of the bicycle P4, the in-vehicle terminal or the like can perform an operation of calling attention to the bicycle P4 to the driver or the like of the vehicle. Of course, in addition to the bicycle P4, in a case where a pedestrian who is actually crossing the road and whose position is outside the pedestrian crossing is found, the pedestrian is also subjected to call attention to the driver or the like of the vehicle.

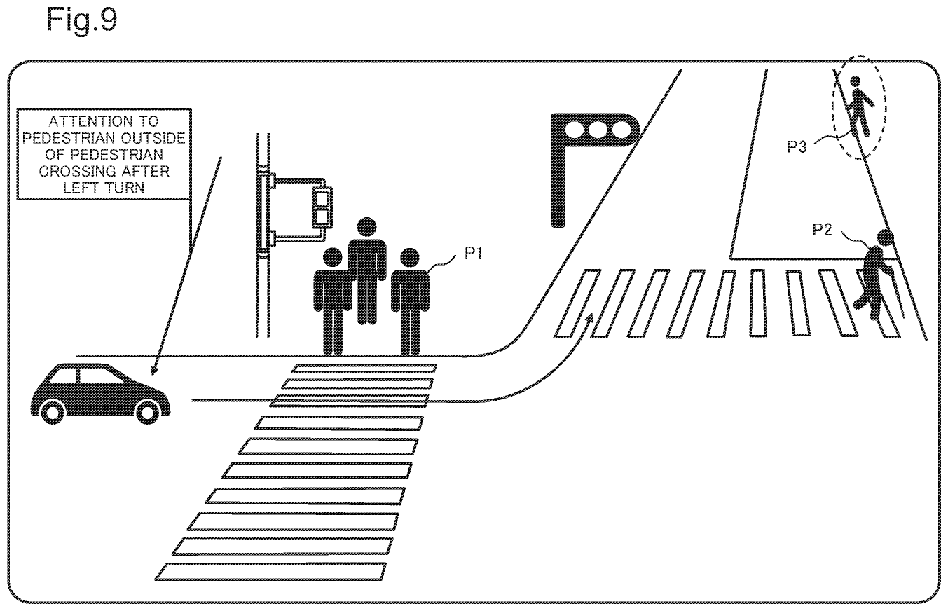

In the examples of FIGS. 7 and 8, it has been described that the server 100 transmits the presence of a pedestrian or a bicycle and the determination result of each crossing position, but the server 100 may create information to be output to the in-vehicle terminal. For example, in a case where the server 100 has grasped the position and the advancing direction of each vehicle and can individually transmit information to each vehicle, the server 100 can create a message for each vehicle. For example, as shown in FIG. 9, when there is a vehicle entering the intersection from the left side of FIG. 9 and making a left turn, the server 100 can create a message “CAREFUL TO PEDESTRIAN OUTSIDE PEDESTRIAN CROSSING AFTER LEFT TURN” for the vehicle and transmit the message to the in-vehicle terminal. Then, the in-vehicle terminal that has received the message outputs the message received from the server by voice or text. In this way, the load on the in-vehicle terminal side can be reduced and the prompt reporting of the attention calling message can be improved.

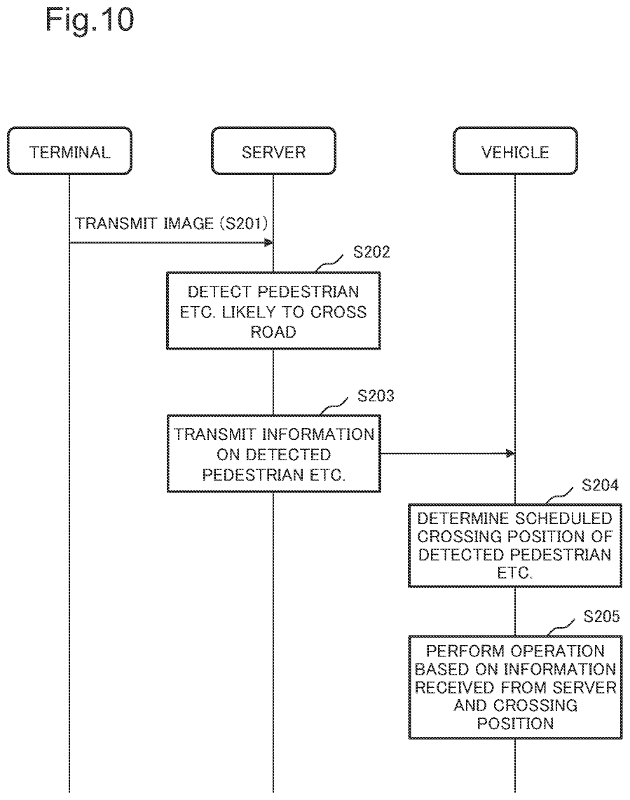

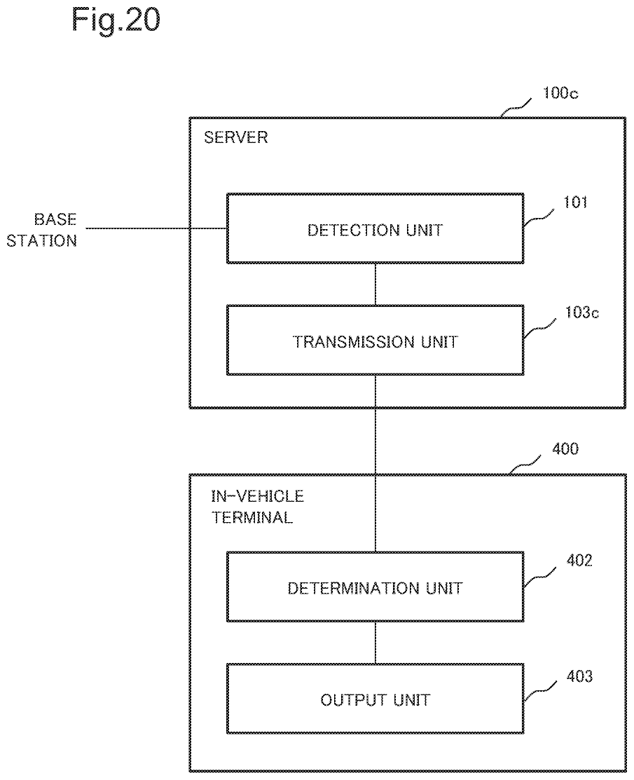

In the above description, it has been described that the server 100 determines the crossing position of the pedestrian or the bicycle, but the vehicle side may determine the crossing position of the pedestrian or the bicycle (see FIG. 10). In this case, a configuration as illustrated in FIG. 20 can be adopted. The server 100c includes a detection means (corresponding to the detection unit 101 in FIG. 20) that detects a person or an animal crossing or likely to cross the road based on an image acquired from a camera capable of photographing the road, and a transmission means (corresponding to the transmission unit 103c in FIG. 20) that transmits the detection result to the vehicle side. The in-vehicle terminal 400 of the vehicle serves as a safe driving assistance device, and includes a means (corresponding to the determination unit 402 in FIG. 20) that determines whether a crossing position of a person or an animal is within a pedestrian crossing based on a detection result of the person or the animal received from the server 100, and a means (corresponding to the output unit 403 in FIG. 20) that outputs the result of the determination. After detecting a pedestrian or a bicycle based on the image acquired from the camera, the server 100c transmits information of the detected pedestrian or bicycle to the vehicle (steps S202 and S203 in FIG. 10). Then, the crossing position of the detected pedestrian or bicycle is determined on the vehicle side (step S203 in FIG. 10). In this way, the load on the server side can be reduced.

### Second Example Embodiment

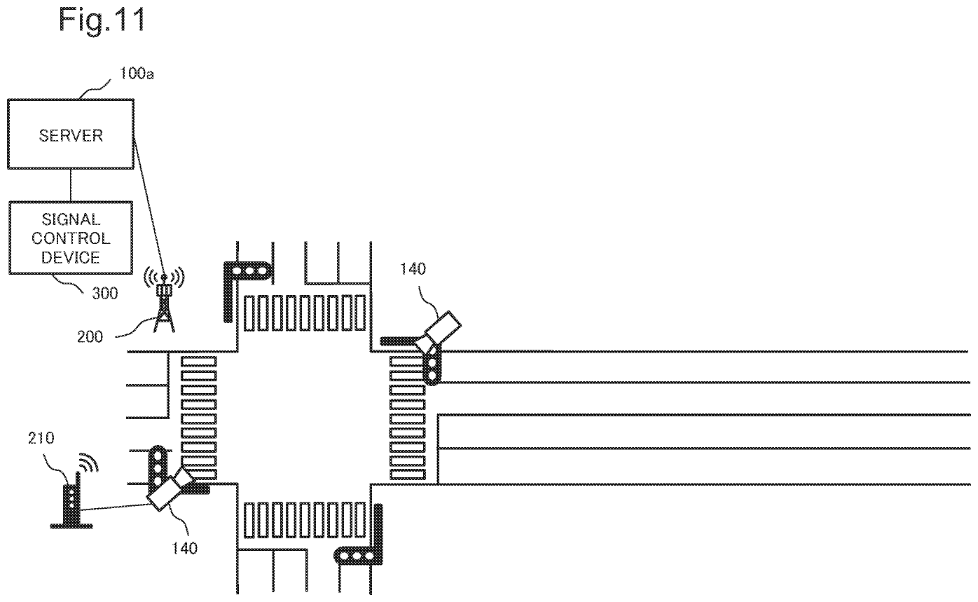

Next, a second example embodiment in which a server provides information on a lighting state (signal indication) of a traffic light at an intersection will be described in detail with reference to the drawings. FIG. 11 is a diagram illustrating a schematic configuration of the second example embodiment of the present invention. A configuration difference from the first example embodiment illustrated in FIG. 4 is that the server 100a is connected to the signal control device 300 and can acquire information on the lighting state of the traffic light. Since the other configurations are the same as those of the first example embodiment, the description thereof will be omitted, and the differences will be mainly described below.

The signal control device 300 is a device that controls the lighting of a traffic light installed at an intersection based on control information set in advance. For example, the signal control device 300 controls a light-on state of a traffic light at an intersection based on information such as a cycle, a split, and an offset.

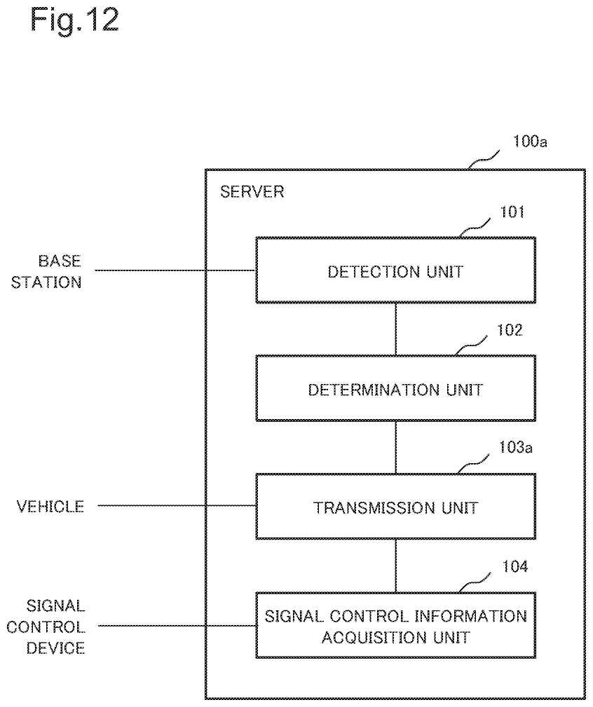

FIG. 12 is a functional block diagram illustrating a configuration of a server 100a according to the second example embodiment of the present invention. The differences from the server 100 of the first example embodiment illustrated in FIG. 5 are that a signal control information acquisition unit 104 is added to the server 100a, and that a transmission unit 103a transmits a light-on state of a traffic light at an intersection in addition to a position and a crossing position of a pedestrian or the like.

The signal control information acquisition unit 104 acquires, from the signal control device 300, information on the lighting state of the traffic light or control information (hereinafter, these are collectively referred to as “signal control information”) serving as a base of the information.

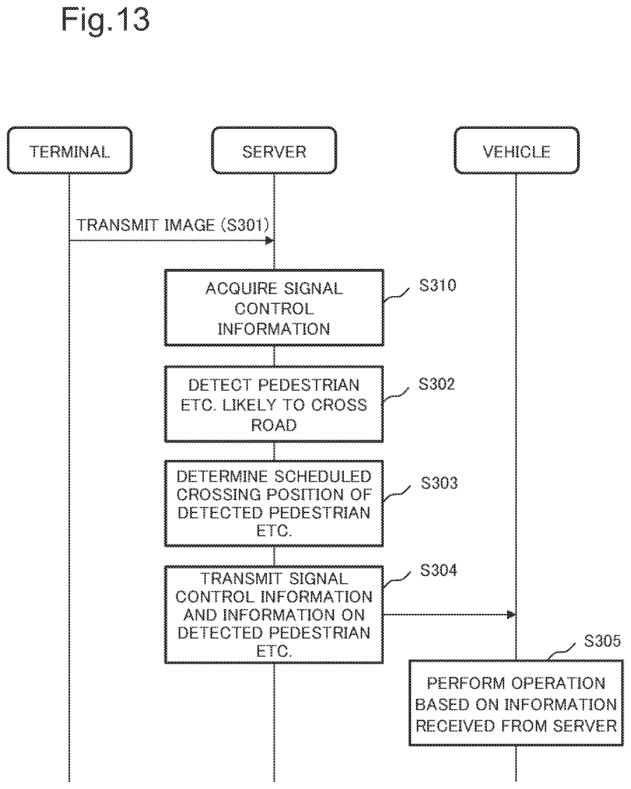

Next, the operation of the present example embodiment will be described in detail with reference to the drawings. FIG. 13 is a sequence diagram illustrating the operation of the second example embodiment of the present invention. Referring to FIG. 13, the terminal 210 transmits the image received from the camera 140 to the server 100a via the base station 200 (step S301).

Thereafter, steps S302 and S303 are similar to steps S102 and S103 of the first example embodiment. Thereafter, the server 100a transmits the signal control information, the position and the crossing position of the detected pedestrian or the like to the vehicle side (step S304).

The in-vehicle terminal of the vehicle that has received the information performs an operation based on the information received from the server 100a. At that time, a large difference from the first example embodiment is that the in-vehicle terminal determines whether to use the information received from the server 100a with reference to the signal control information in addition to the position, the moving direction, and the moving speed of the own vehicle. For example, even if there is a pedestrian who is about to cross the outside of the pedestrian crossing on the road ahead of the own vehicle, if the lighting state of the traffic light turns red at the time of passing through the relevant intersection and it is expected that the vehicle will stop, the in-vehicle terminal that has received the information discards these pieces of information. In addition, for example, there is a case where the own vehicle is about to turn left and there is a pedestrian who is about to cross the outside of a pedestrian crossing on a road ahead of the left turn. In this case, if it is expected that the vehicle can turn left depending on the lighting state of the traffic light, the in-vehicle terminal calls attention of the driver. Whether the own vehicle is about to turn left can be determined by, for example, whether a left turn indicator is turned on. In this manner, the in-vehicle terminal performs the attention calling operation to the driver only in a case where crossing with a pedestrian who is about to cross outside of the pedestrian crossing is expected based on the lighting state of the traffic light.

As described above, according to the present example embodiment, it is possible to cause the in-vehicle terminal or the like of the vehicle to perform the attention calling operation to the pedestrian in consideration of the lighting state of the traffic light. Furthermore, the control of whether to call attention to the driver using the signal control information is not limited to the above example. For example, it is possible to cause the in-vehicle terminal to calculate the degree of occurrence of crossing between the vehicle and a pedestrian who is about to cross the outside of the pedestrian crossing with reference to the signal control information. Then, the in-vehicle terminal may perform an attention calling operation to different drivers according to this degree. For example, when the degree is large, the notification can be given to the driver in a more noticeable manner. Furthermore, when the degree is large, the degree information may be used for control of the vehicle itself such as decelerating the vehicle.

In the example embodiment described above, the in-vehicle terminal determines whether to perform the attention calling operation to the driver based on the information received from the server 100a, but the server 100a may determine whether to perform the attention calling operation. In this case, the server 100a determines whether a crossing between the vehicle and a pedestrian who is about to cross the outside of the pedestrian crossing is expected based on the position, the moving direction, and the moving speed of the target vehicle, as well as the lighting state of the signal. For example, even if there is a pedestrian who is about to cross the outside of the pedestrian crossing on the road ahead of the target vehicle, if the target vehicle is expected to stop according to the signal light, the server 100a suppresses transmission of the position and crossing position of the detected pedestrian or the like. This makes it possible to transmit the result of the determination to a vehicle having the possibility of crossing a person, a bicycle, an animal, or the like. In addition, also in a case where the server 100a side determines whether to perform the attention calling operation, the server 100a side can be caused to calculate the degree of occurrence of the crossing between the vehicle and the pedestrian who is about to cross the outside of the pedestrian crossing with reference to the signal control information, and use the degree to call attention to the driver and control the vehicle.

### Third Example Embodiment

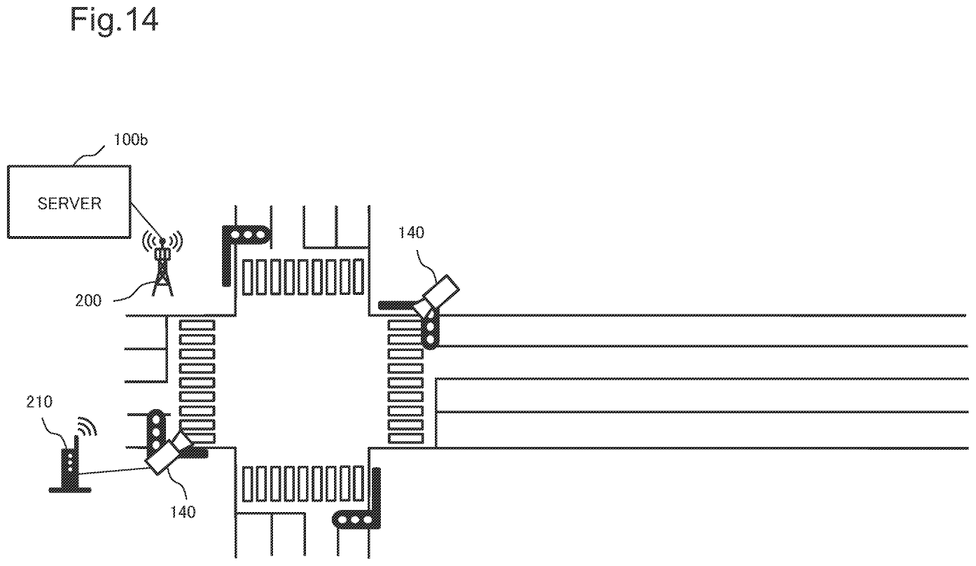

Next, a third example embodiment in which a server provides a moving direction and a moving speed in addition to the positions of a pedestrian and a bicycle will be described in detail with reference to the drawings. FIG. 14 is a diagram illustrating a schematic configuration of the third example embodiment of the present invention. Since the basic configuration is similar to the configuration of the first example embodiment illustrated in FIG. 4, the difference will be mainly described below.

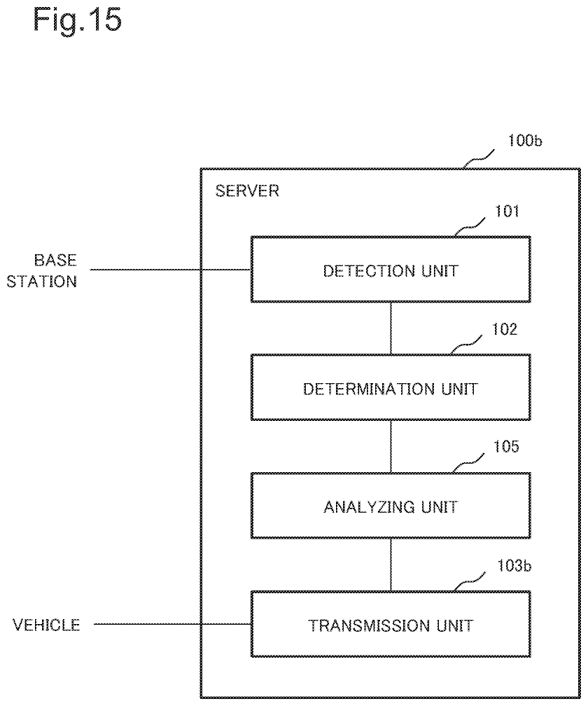

FIG. 15 is a functional block diagram illustrating a configuration of a server 100b according to the third example embodiment of the present invention. The differences from the server 100 of the first example embodiment illustrated in FIG. 5 are that an analyzing unit 105 is added to the server 100a, and that a transmission unit 103b transmits a moving direction and a moving speed of a pedestrian or the like in addition to a position and a crossing position of the pedestrian or the like.

More specifically, the analyzing unit 105 analyzes a moving direction and a moving speed of a pedestrian or a bicycle based on a plurality of images captured by the camera 140. The moving direction and the moving speed of the pedestrian or the bicycle can be estimated using the movement and the moving amount of the subject shown in two or more temporally continuous images.

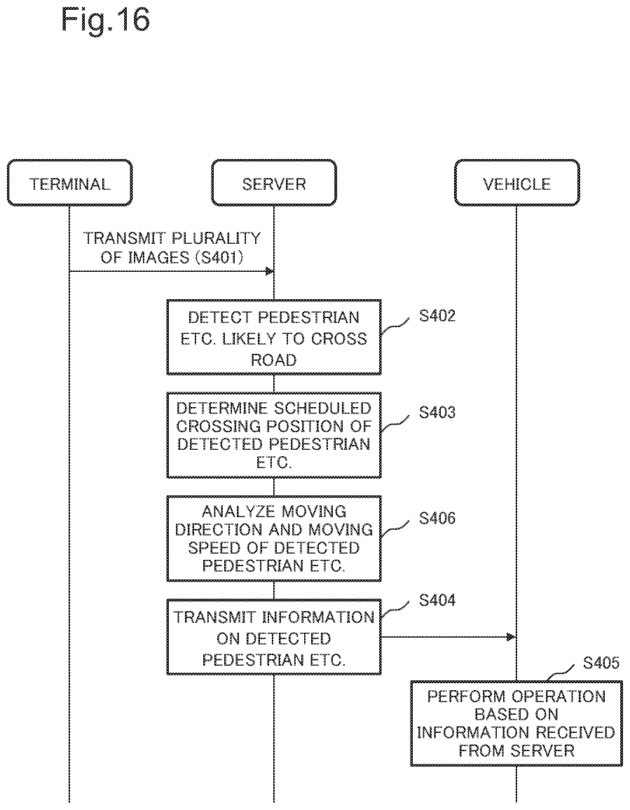

Next, the operation of the present example embodiment will be described in detail with reference to the drawings. FIG. 16 is a sequence diagram illustrating the operation of the third example embodiment of the present invention. The operations shown in steps S401 to S405 of FIG. 16 correspond to S101 to S105 of the first example embodiment.

The operation added in the present example embodiment is the analyzing process of the moving direction and the moving speed of the pedestrian or the like in step S406. The process in step S406 may be performed before the determination of the crossing position in step S403.

After completion of the analysis of the moving direction and the moving speed of the pedestrian or the like, the server 100b transmits the position, crossing position, moving direction, and moving speed of the detected pedestrian or the like to the vehicle side (step S404).

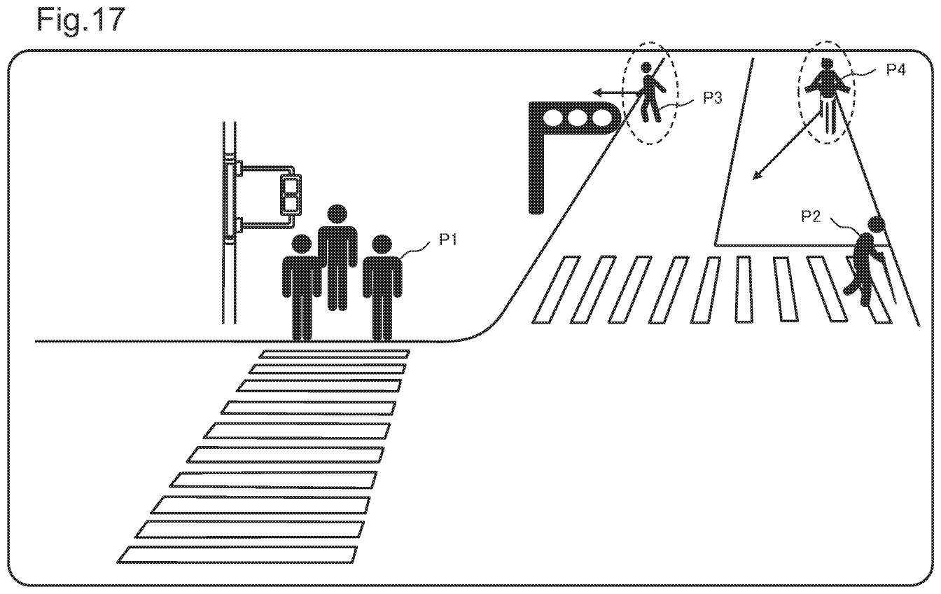

The in-vehicle terminal of the vehicle that has received the information performs an operation based on the information received from the server 100b. For example, as illustrated in FIG. 17, when a pedestrian P3 or a bicycle P4 who is about to cross the outside of the pedestrian crossing on the road ahead of the own vehicle is detected, the in-vehicle terminal displays the position of the pedestrian P3 or the bicycle P4 by AR display or the like. Furthermore, the in-vehicle terminal displays a moving direction and a moving speed of the pedestrian or the like with an arrow. In the example of FIG. 17, the moving speed is represented by the length of the arrow and the moving direction is represented by the direction of the arrow, but the display form of the moving direction and the moving speed is not limited thereto. For example, the moving speed can also be represented by a numerical value, a thickness of an arrow, or a color. Similarly, the moving direction can also be represented by a symbol indicating an azimuth.

According to the present example embodiment in which the moving direction and the moving speed are performed in addition to the position of the pedestrian or the bicycle, it is possible to visually represent an object to which attention should be paid with a high possibility of crossing or the like for the own vehicle. For example, in the case of FIG. 17, there is a pedestrian P3 and a bicycle P4 as the pedestrian and bicycle outside of the pedestrian crossing, but it can be seen that the bicycle P4 has a faster speed and is approaching the own vehicle. The driver of the vehicle can decelerate or perform an avoidance operation based on such information.

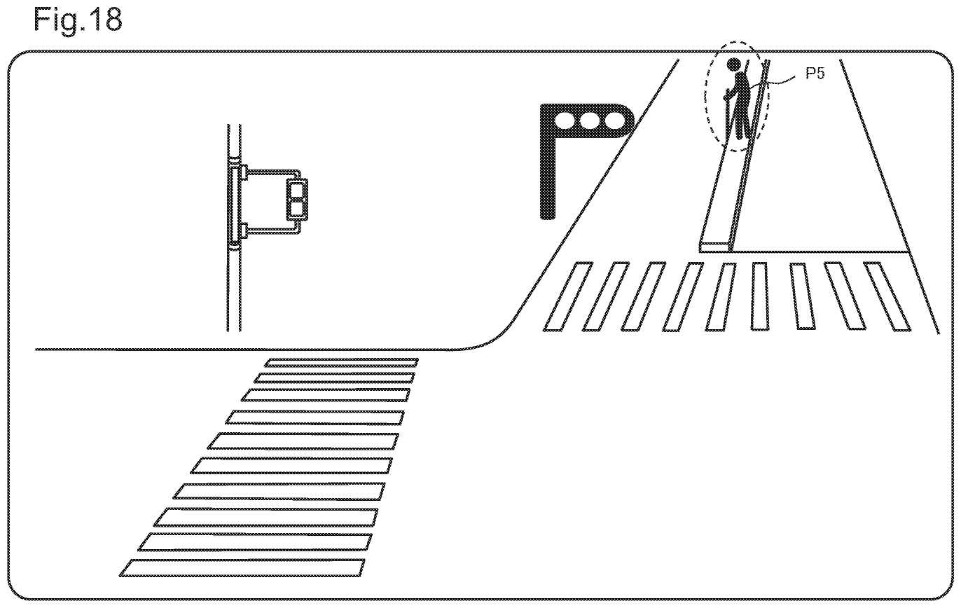

Furthermore, according to the present example embodiment, as illustrated in FIG. 18, movement of a pedestrian or the like waiting at the medial strip or the zebra zone can be identified. For example, in the case of FIG. 18, there is a pedestrian P5 crossing the outside of the pedestrian crossing, but since the pedestrian is waiting at the medial strip, it is possible to notify the driver that there is little risk of immediately crossing the pedestrian.

In addition, the moving direction and the moving speed of the pedestrian or the like obtained in the present example embodiment may be used not only for the display but also for the determination of the presence or absence of occurrence of the crossing and the degree of occurrence of the crossing on the on-vehicle terminal or the server 100b side. Furthermore, the in-vehicle terminal or the server 100b may control the vehicle (automatic deceleration, attention calling notification etc.) according to the moving direction and the moving speed.

Although the embodiments of the present invention have been described above, the present invention is not limited to the above-described embodiments, and further modifications, substitutions, and adjustments can be made without departing from the basic technical idea of the present invention. For example, the configuration of the system, the configuration of each element, and the expression form of data and the like illustrated in the drawings are examples for assisting the understanding of the present invention, and are not limited to the configurations illustrated in the drawings. For example, in the first to third embodiments described above, it has been described that the camera 140 is installed at the intersection, but the arrangement of the camera 140 is not limited thereto. For example, a camera installed on a street or a camera installed for crime prevention can be used as the camera 140.

In each of the embodiments described above, the description has been given assuming that the server side determines whether the crossing position of the pedestrian or the like is within the pedestrian crossing, but a configuration in which the vehicle (in-vehicle terminal) determines whether the crossing position is within the pedestrian crossing can also be adopted. In this case, a pedestrian or the like is detected from the server, and the position thereof is transmitted to the vehicle (in-vehicle terminal) side.

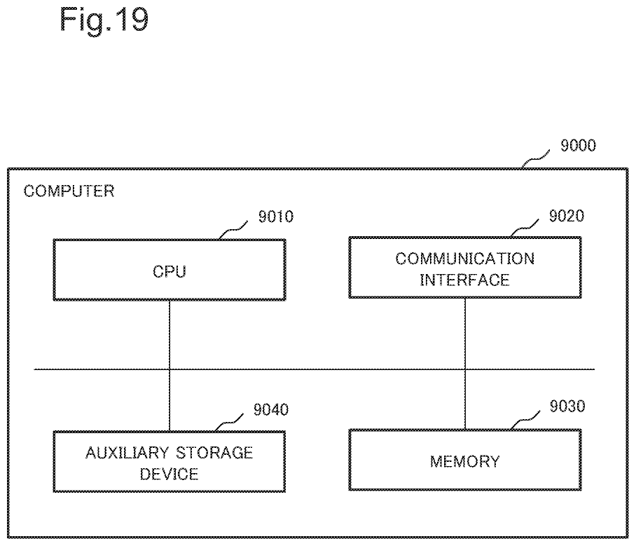

In addition, the procedure described in each of the above embodiments can be achieved by a computer that functions as a device configuring a safe driving assistance system or a safe driving assistance device on the vehicle side. Specifically, the procedure can be implemented by a program for causing a computer (9000 in FIG. 19) to implement functions as these devices. Such a computer is exemplified in a configuration including a central processing unit (CPU) 9010, a communication interface 9020, a memory 9030, and an auxiliary storage device 9040 in FIG. 19. That is, the CPU 9010 in FIG. 19 may execute an object recognition program or the crossing position determination program. The computer executes the safe driving assistance method by the program.

That is, each unit (processing means and function) such as the server or the like described above can be achieved by a computer program that causes a processor mounted in each of these devices to execute each of the processes described above using the hardware. The program can be recorded in a computer-readable program-recording medium. The storage medium may be a non-transient (non-transitory) medium such as a semiconductor memory, a hard disk, a magnetic recording medium, or an optical recording medium.

Some or all of the above embodiments may be described as the following supplementary notes, but are not limited to the following.

### [Supplementary Note 1]

A safe driving assistance system including:
a detection means that detects a person or an animal crossing or likely to cross a road based on an image acquired from a camera capable of photographing the road,
a determination means that determines whether a crossing position of the detected person or animal is within a pedestrian crossing, and
an output means that outputs result of the determination.

### [Supplementary Note 2]

The safe driving assistance system according to supplementary note 1, wherein the camera is a camera installed near a traffic light at an intersection.

### [Supplementary Note 3]

The safe driving assistance system according to supplementary note 2, wherein the output means outputs result of the determination to a vehicle located near the intersection.

### [Supplementary Note 4]

The safe driving assistance system according to supplementary note 2 or 3, further including:
a means that acquires information indicating a state of lighting of the traffic light at the intersection, wherein
the output means provides information indicating a state of lighting of the traffic light at the intersection in addition to the result of the determination.

### [Supplementary Note 5]

The safe driving assistance system according to supplementary note 2 or 3, further including:
a means that acquires information indicating a state of lighting of a traffic light at the intersection, wherein
the output means transmits the result of the determination to a vehicle having a possibility of crossing the person or the animal based on the information indicating the state of lighting of the traffic light at the intersection.

### [Supplementary Note 6]

The safe driving assistance system according to any one of supplementary notes 1 to 5, further including:
a means that analyzes at least one of a moving direction and a moving speed of the person or the animal, wherein
the output means provides at least one of the moving direction and the moving speed of the person or the animal in addition to the result of the determination.

### [Supplementary Note 7]

The safe driving assistance system according to any one of supplementary notes 2 to 5, wherein the detection means detects a person or an animal likely to cross a road connected to the intersection from an image shown in an image captured by the camera.

### [Supplementary Note 8]

The safe driving assistance system according to any one of supplementary notes 1 to 7, wherein the determination means determines whether a crossing position of the person or the animal is within a pedestrian crossing based on a position in the image of the image shown in the image captured by the camera.

### [Supplementary Note 9]

A safe driving assistance device connected to a server including a detection means that detects a person or an animal crossing or likely to cross a road based on an image acquired from a camera capable of photographing the road, and a transmission means that transmits the detection result of the person or the animal, the safe driving assistance further including:
a means that determines whether a crossing position of the person or the animal is within a pedestrian crossing based on the detection result of the person or the animal received from the server, and
a means that outputs result of the determination.

### [Supplementary Note 10]

The safe driving assistance device according to supplementary note 9, wherein
information indicating a state of lighting of a traffic light at the intersection is received from the server, and
the result of the determination is output when an own vehicle has a possibility of crossing the person or the animal based on the information indicating the state of lighting of the traffic light at the intersection.

### [Supplementary Note 11]

A safe driving assistance method including:
detecting a person or an animal crossing or likely to cross a road based on an image acquired from a camera,
determining whether a crossing position of the detected person or animal is within a pedestrian crossing, and
outputting the result of the determination.

### [Supplementary Note 12]

A safe driving assistance method including:
receiving, from a server including a detection means that detects a person or an animal crossing or likely to cross a road based on an image acquired from a camera capable of photographing the road, and a transmission means that transmits the detection result of the person or the animal, the detection result of the person or the animal,
determining whether a crossing position of the person or the animal is within a pedestrian crossing based on the detection result of the person or the animal received from the server, and
outputting result of the determination.

### [Supplementary Note 13]

A program-recording medium recorded with a program for causing a computer capable of acquiring an image from a camera to execute:
a process of detecting a person or an animal crossing or likely to cross a road based on an image acquired from a camera,
a process of determining whether a crossing position of the detected person or animal is within a pedestrian crossing, and
a process of outputting result of the detection and result of the determination.

Note that the forms of the supplementary notes 9 to 13 can be developed to the forms of the supplementary notes 2 to 8, similarly to the form of the supplementary note 1.

Note that the disclosure of the above patent documents is incorporated herein by reference. Within the frame of the entire disclosure (including the claims) of the present invention, it is possible to change and adjust the embodiments or examples further based on the basic technical idea thereof. In addition, various combinations or selections (including partial deletions) of various disclosed elements (including each element of each claim, each element of each embodiment or example, each element of each drawing, and the like) can be made within the frame of the disclosure of the present invention. That is, it is a matter of course that the present invention includes various modifications and corrections that can be contrived by those skilled in the art in accordance with the entire disclosure including the claims and the technical idea. In particular, for numerical ranges set forth herein, any numerical value or sub-range included within the range should be construed as being specifically described, even if not stated otherwise.

### REFERENCE SIGNS LIST

10 safe driving assistance system
11 detection means
12 determination means
13 output means
14, 140 camera
100, 100a, 100b, 100c server
101 detection unit
102 determination unit
103, 103a, 103b transmission unit
104 signal control information acquisition unit
105 analyzing unit
200 base station
210 terminal
300 signal control device
400 In-vehicle terminal
402 determination unit
403 output unit
9000 computer
9010 CPU
9020 communication interface
9030 memory
9040 auxiliary storage device
P1 to P3, P5, P11, P13 pedestrian
P4, P12 bicycle
P14 animal

What is claimed is:

1. A safe driving assistance system comprising:
at least one memory configured to store instructions; and
at least one processor configured to execute the instructions to:
detect a person or an animal crossing or likely to cross a road based on an image acquired from a camera capable of photographing the road;
determine whether a crossing position of the detected person or animal is within a pedestrian crossing; and
output result of the determination.

2. The safe driving assistance system according to claim 1, wherein
the camera is a camera installed near a traffic light at an intersection.

3. The safe driving assistance system according to claim 2, wherein the at least one processor is further configured to execute the instructions to:
output the result of the determination to a vehicle located near the intersection.

4. The safe driving assistance system according to claim 2, wherein the at least one processor is further configured to execute the instructions to:
acquire information indicating a state of lighting of the traffic light at the intersection; and
output information indicating a state of lighting of the traffic light at the intersection in addition to result of the determination.

5. The safe driving assistance system according to claim 2, wherein the at least one processor is further configured to execute the instructions to: c
acquire information indicating a state of lighting of the traffic light at the intersection; and
output result of the determination to a vehicle having a possibility of crossing the person or the animal based on the information indicating the state of lighting of a traffic light at the intersection.

6. The safe driving assistance system according to claim 2, wherein the at least one processor is further configured to execute the instructions to:
analyze at least one of a moving direction and a moving speed of the person or the animal; and
output at least one of the moving direction and the moving speed of the person or the animal in addition to the result of the determination.

7. The safe driving assistance system according to claim 2, wherein the at least one processor is further configured to execute the instructions to:
detect a person or an animal likely to cross a road connected to the intersection from an image shown in an image captured by the camera.

8. The safe driving assistance system according claim 1, wherein the at least one processor is further configured to execute the instructions to:
determine whether a crossing position of the person or the animal is within a pedestrian crossing based on a position in the image of the image shown in the image captured by the camera.

9. (canceled)

10. (canceled)

11. A safe driving assistance method comprising:
detecting a person or an animal crossing or likely to cross a road based on an image acquired from a camera;
determining whether a crossing position of the detected person or animal is within a pedestrian crossing, and
outputting the result of the determination.

12. (canceled)

13. A program-recording medium non-transiently recording a program for causing a computer capable of acquiring an image from a camera to execute:
a process of detecting a person or an animal crossing or likely to cross a road based on an image acquired from a camera,
a process of determining whether a crossing position of the detected person or animal is within a pedestrian crossing, and
a process of outputting result of the detection and result of the determination.
